(19) United States
(12) Patent Application Publication
(10) Pub. No.: US 2012/0024921 A1
(43) Pub. Date: Feb. 2, 2012

(54) CARGO CLOSURE TIE-DOWN AND METHOD FOR TYING-DOWN A CARGO CLOSURE OF A VEHICLE

(76) Inventor: Arthur Pryor, Delray Beach, FL (US)

(21) Appl. No.: 12/846,282

(22) Filed: Jul. 29, 2010

(51) Int. Cl. B60R 9/00

(52) U.S. Cl. 224/315

(57) ABSTRACT

A method and a device for tying-down a cargo closure hinged to a body of a vehicle and having a hinged edge and a locking edge. A first portion of a strap is attached to the vehicle body and a second portion of the strap is attached to the hinged edge. The strap is tightened, in particular from outside the cargo area and outside the cargo closure, to hold down the cargo closure. A hook, in particular an S-hook, may be used for attaching the first portion of the strap to the vehicle body and a flat hook may be used for attaching the second portion of the strap to the hinged edge. A cam lock, ratchet tightening mechanism or other device disposed on the strap is used to tighten the strap. The cargo closure may be a trunk lid, a tail gate, a door or doors.

### BACKGROUND OF THE INVENTION

1. Field of the Invention

The invention relates to a cargo closure tie-down and a method for tying-down a cargo closure of a vehicle. Cargo closures include trunk lids, tail gates and doors. Such devices are used to temporarily tie-down a trunk lid, tail gate, door or doors when objects are placed in a trunk or other cargo area that are too large to allow the closure to be locked in a closed position.

2. Description of the Related Art

U.S. Pat. No. 5,845,370 discloses a self-locking trunk tie-down mechanism, but does not disclose how it is attached. Similarly, U.S. Pat. No. 4,666,194 discloses a trunk lid fastening device, but only states that it is attached at one end to a striker or tailgate lock.

U.S. Pat. No. 5,297,828 pertains to a trunk lid tie down between a hook 12 of a lid and a latch 14 of a trunk lock. Similarly, U.S. Pat. No. 6,648,381, U.S. Pat. No. 5,647,619 and U.S. Pat. No. 4,191,413 disclose a trunk tie-down connected between two parts of a trunk lock, within the trunk.

U.S. Pat. No. 4,188,061 teaches a trunk lid holder connected between a trunk lid and a trunk bed, within the trunk.

U.S. Pat. No. 4,659,122 shows a trunk tie-down in which a hook is hooked into one of a series of holes in a strand having one end fastened inside the rear wall of a trunk and another end wound inside a reel mounted inside the trunk lid.

U.S. Pat. No. 2,973,217 illustrates a trunk lid tie-down connected between a part of a lock on the trunk lid and a bumper.

U.S. Pat. No. 2,983,413 shows a cargo securing device for cargo on top of a trunk lid.

U.S. Pat. No. 6,637,077 B2 discloses an adjustable strap for boats, planes and motorcycles.

U.S. Pat. No. 65,891 shows a car coupling with a drawbar.

All of the cargo closures or trunk lid tie-down devices of the prior art are connected completely within the trunk or cargo area or from the trunk lid or closure to the bumper. For that reason, they are difficult to adjust and cannot be made very tight, so that the cargo closure will bounce open and closed when the vehicle moves.

### BRIEF SUMMARY OF THE INVENTION

It is accordingly an object of the invention to provide a cargo closure tie-down and a method for tying-down a cargo closure of a vehicle, which overcome the hereinafore-mentioned disadvantages of the heretofore-known devices and methods of this general type and which allow a lid, tail gate, door or doors to be held down without play by an adjustment from outside the lid, tail gate, door or doors when objects are placed in the trunk or cargo area that do not allow the lid, tail gate, door or doors to be completely closed and locked with a locking mechanism.

With the foregoing and other objects in view there is provided, in accordance with the invention, method for tying-down a cargo closure hinged to a body of a vehicle and having a hinged edge and a locking edge. The method comprises attaching a first portion of a strap to the vehicle body, attaching a second portion of the strap to the hinged edge, and tightening the strap to hold down the cargo closure.

With the objects of the invention in view, there is also provided, in combination with a vehicle having a cargo closure being hinged to a body of the vehicle and having a hinge edge and a locking edge, a cargo closure tie-down comprising a strap having a first portion to be attached to the vehicle body and a second portion to be attached to the hinged edge of the cargo closure, and a device for tightening the strap to hold down the cargo closure.

Thus, the strap of the invention is attached between the hinged edge of the cargo closure and the vehicle body, so that it passes over the outside of the cargo closure and may be easily connected and tightened by a user of the device from outside of the cargo area and outside of the cargo closure.

In accordance with another feature of the invention, the first portion of the strap is attached to the vehicle body with an S-hook and the second portion of the strap is attached to the hinged edge of the cargo closure with a flat hook. The S-hook is attached to a locking mechanism of the vehicle or to a bumper of the vehicle or to an edge of a wheel well of the vehicle.

In accordance with a concomitant feature of the invention, the strap is tightened with a cam lock or a ratchet tightening mechanism or another device, such as a spring cam buckle, O-ring, D-ring, side-release buckle, loop, cord lock, snap lock, center release buckle or tongue buckle on the strap.

Other features which are considered as characteristic for the invention are set forth in the appended claims.

Although the invention is illustrated and described herein as embodied in a cargo closure tie-down and a method for tying-down a cargo closure of a vehicle, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawings.

### BRIEF DESCRIPTION OF THE SEVERAL VIEWS OF THE DRAWING

FIG. 1 is a diagrammatic, rear-perspective view of the tie-down of the invention installed on a trunk lid of a sedan and attached to a locking mechanism of the automobile;

FIG. 2 is a rear-perspective view of the tie-down of the invention installed on a trunk lid of a sedan and attached to a bumper of the automobile;

FIG. 3 is a rear-elevational view of the tie-down of the invention installed on a tail gate of an SUV or minivan and attached to a bumper thereof;

FIG. 4 is a rear-perspective view of the tie-down of the invention installed on a rear door of a station wagon and attached at the wheel well thereof;

FIG. 5 is a rear-elevational view of the tie-down of the invention installed across two rear doors of an SUV and attached at the wheel well thereof;

FIG. 6 is a fragmentary, perspective view of the tie-down of the invention;

FIG. 7 is a fragmentary, perspective view of the tie-down of the invention having a ratchet tightening mechanism;

FIG. 8 is a perspective view of a flat hook of the tie-down of the invention;

FIG. 9 is an elevational view of an S-hook of the tie-down of the invention; and

FIG. 10 is a perspective view of a cam lock of the tie-down of the invention.

### DETAILED DESCRIPTION OF THE INVENTION

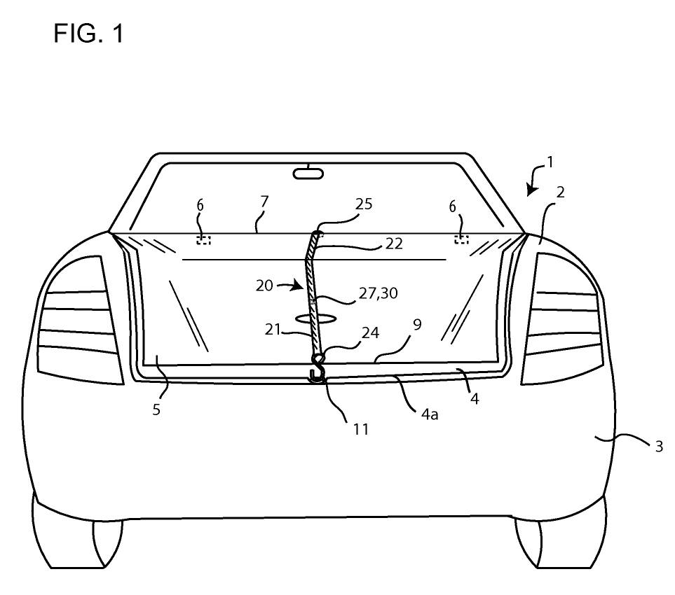

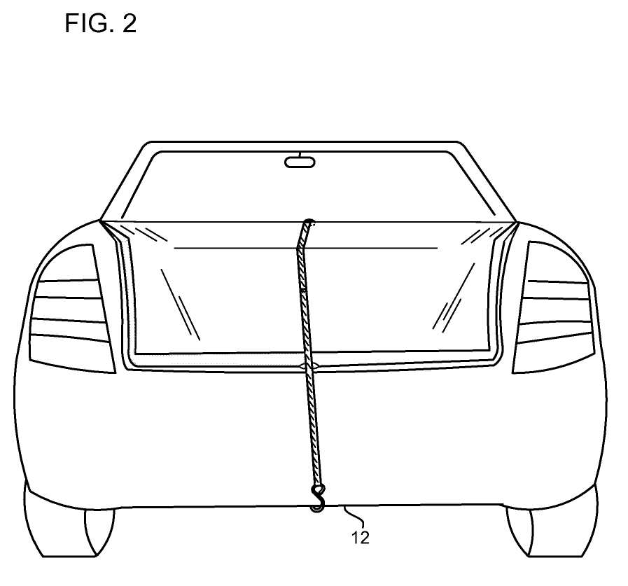

Referring now to the figures of the drawing in detail and first, particularly, to FIG. 1 thereof, there is seen a sedan 1 having a body 2 with a bumper 3, a cargo area in the form of a trunk having an opening 4 and a cargo closure in the form of a trunk lid 5. The lid 5 is hinged to the body 2 by hinges 6 in a conventional manner near a front or hinged edge 7 of the lid and may be locked to the body at a rear or locking edge 9 of the lid through the use of a conventional locking or latching mechanism, only a loop or striker 11 of which is illustrated in FIG. 1. The loop 11 is normally fixed in the vicinity of an edge 4a of the opening 4 and is to be engaged by a hook on the lid 5. The edges 7, 9 are disposed opposite one another along a longitudinal direction running from the front to the back of the vehicle 1 or from the hinged edge 7 to the locking edge 9. The hinges 6 for the lid may be spring hinges which tend to keep the lid open when not locked. Whereas FIG. 1 shows a cargo closure tie-down 20 of the invention engaging the rear or locking edge 9 of the lid 5, FIG. 2 shows the cargo closure tie-down 20 engaging a bottom edge 12 of the bumper 3, in a manner which will be explained in detail below.

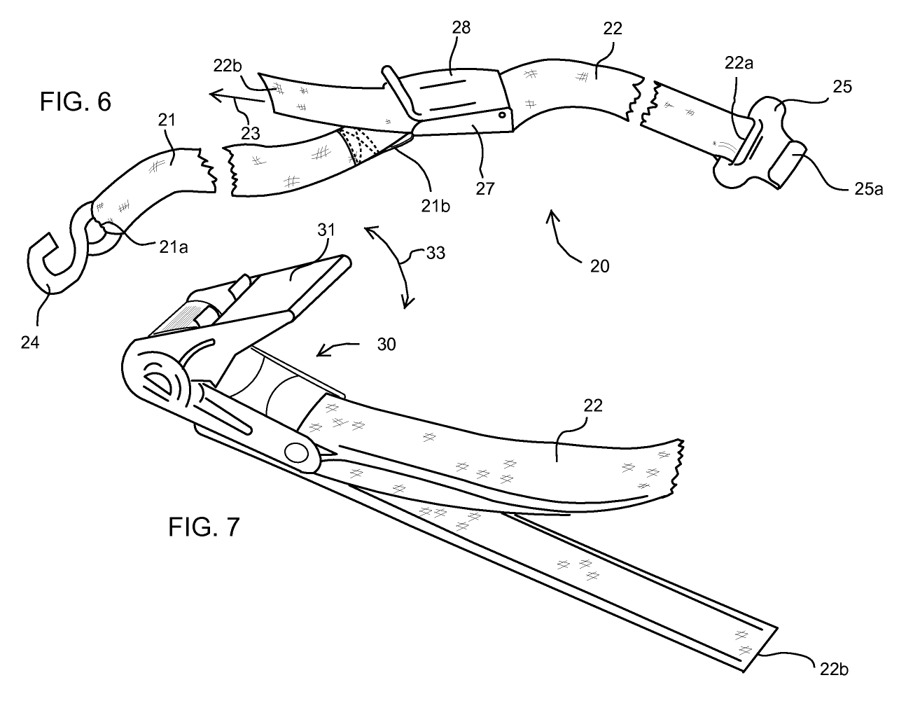

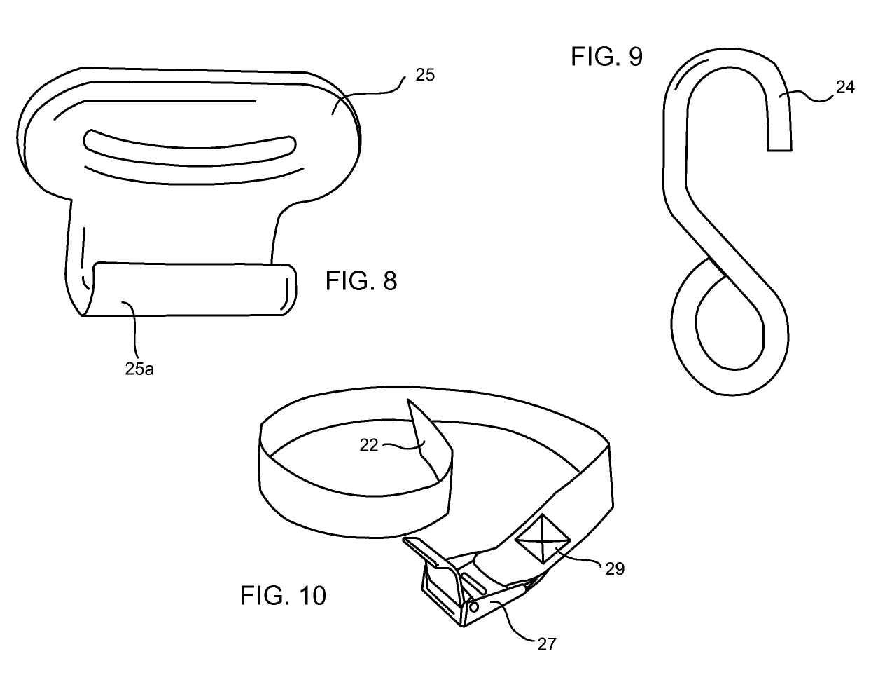

The cargo closure tie-down 20 of the invention, as seen in FIG. 6, includes a strap having a first portion 21 and a second portion 22. The strap is shown with two breaks in the drawing, illustrating that any suitable length of the strap may be chosen, depending on the size of the cargo closure to be tied down. The first portion 21 has a first end 21a and a second end 21b. The first end 21a passes through an opening in an S-hook 24 and may be stitched together or otherwise fastened to the S-hook. Any hook may be used in place of an S-hook. The second portion 22 has a first end 22a and a second end 22b. The first end 22a passes through an opening in a flat hook 25 and may be similarly stitched together or otherwise fastened to the flat hook. The second end 21b passes through non-illustrated slots in the bottom of a cam lock 27 and is stitched together or otherwise fastened to itself. The second end 22b passes through the cam lock 27 for adjusting the effective length of the tie-down 20 when in use by pulling the end 22b in the direction of the arrow 23 and folding down a cover 28. Other length adjusting devices can be used for the tie-down 20 as well, such as a conventional spring cam buckle, O-ring, D-ring, side-release buckle, loop, cord lock, snap lock, center release buckle or tongue buckle. The flat hook 25, the S-hook 24 and the cam lock 27 are respectively shown in greater detail in FIGS. 8, 9 and 10. A U-shaped clip 25a of the flat hook 25 is shown in FIG. 8 and the above-mentioned stitching 29 is shown in FIG. 10 as well.

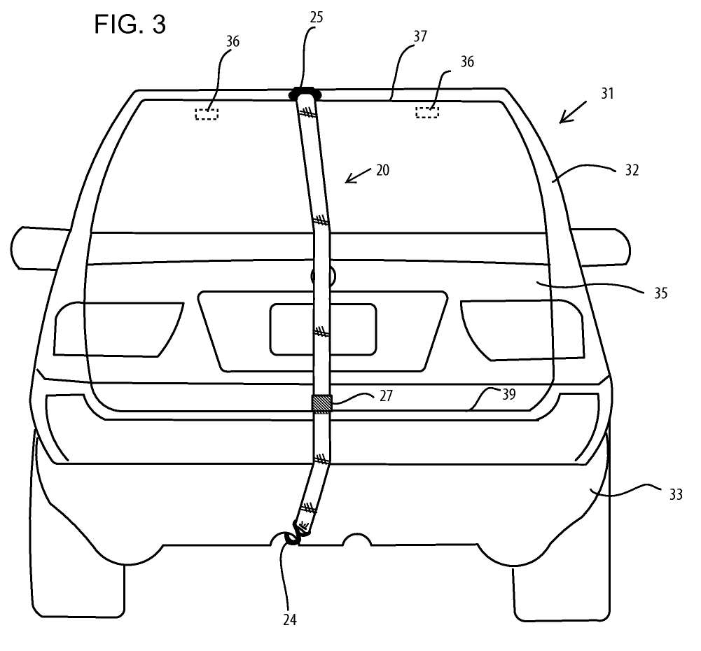

FIGS. 3, 4 and 5 show how the tie-down of the invention can be installed on vehicles with different body styles. More specifically, FIG. 3 illustrates an SUV (sport utility vehicle) or minivan 31 having a body 32 with a bumper 33, a cargo area and a cargo closure in the form of a tail gate 35 to be tied down. The tail gate 35 has an upper hinged edge 37 at which hinges 36 connect the tail gate to the body 32 and a lower locking edge 39 opposite the upper edge 37. The flat hook 25 of the tie-down 20 of the invention engages the upper hinged edge 37 of the tail gate 35, the S-hook 24 thereof engages the bumper 33 and the cam lock 27 is shown therebetween. Of course, the S-hook 24 could also be hooked on a loop of a locking mechanism at the lower locking edge 39 of the tail gate, as illustrated for the sedan in FIG. 1.

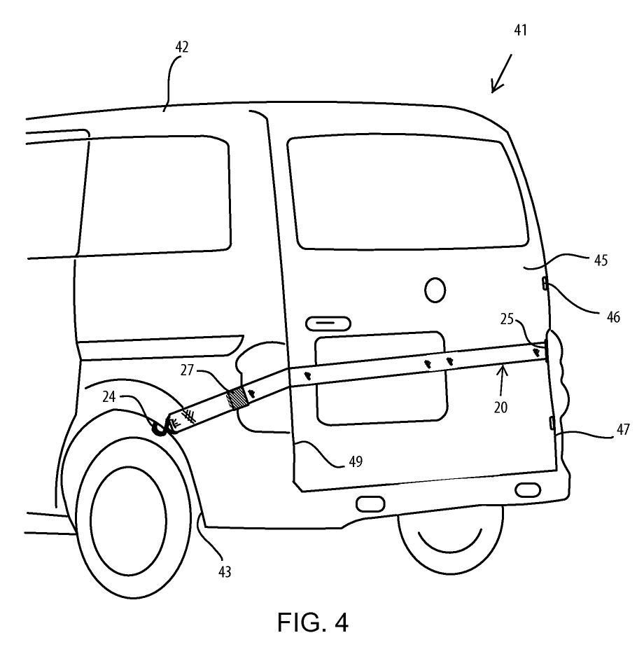

FIG. 4 shows a station wagon 41 having a body 42. The body includes a wheel well having an edge 33. A cargo closure in the form of a rear door 45 covering a cargo area in the body has a hinged edge 47 at which hinges 46 are located and an opposite locking edge 39 at which a locking mechanism is located. The flat hook 25 of the tie-down 20 of the invention engages the hinged edge 47 of the tail gate 45, the S-hook 24 thereof engages the edge 43 of the wheel well and the cam lock 27 is shown therebetween. Of course, the S-hook 24 could also be hooked on a loop of a locking mechanism at the locking edge 49 of the rear door 45, as illustrated for the sedan in FIG. 1.

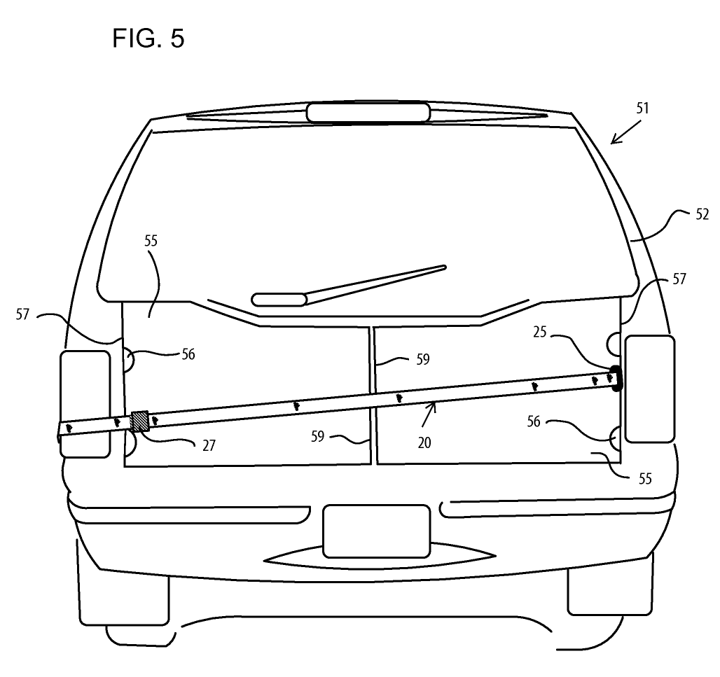

FIG. 5 illustrates an SUV 51 having a body 52 with a cargo area, two cargo closures in the form of rear doors 55 each having a hinged edge 57 at which hinges 56 are located and an opposite locking edge 59 at which a locking mechanism is located. The flat hook 25 of the tie-down 20 of the invention engages the hinged edge 57 of the tail gate 55 on the right, the S-hook 24 thereof engages an edge of a non-illustrated wheel well at the left as shown in FIG. 4 and the cam lock 27 is seen therebetween. Of course, the S-hook 24 could also be hooked on a loop of a locking mechanism at the locking edge 59 of the rear door 55 on the right, as illustrated for the sedan in FIG. 1. Two tie-downs 20 could also be used, one on each door, with the flat hooks on the hinged edges and the S-hooks on the loops as shown in FIG. 1.

FIG. 7 shows a ratchet tightening mechanism 30 which may be used as an alternative to the cam lock 27. The ratchet tightening mechanism 30 has a handle 31 which is rotated for tightening the strap 21, 22 after passing the second end 21b through the ratchet tightening mechanism 30. The surface of the ratchet tightening mechanism 30 may be coated or covered with a coating such as Teflon® or a material such as a textile fabric, to prevent scratching the cargo closure. The S-hook 24 and the flat hook 25 are formed of plastic or metal and may be similarly coated or covered.

Returning to FIGS. 1-5, the cargo closure tie-down 20 of the invention is used by placing the U-shaped clip 25a of the flat hook 25 on the hinged edge 7, 37, 47, 57. The S-hook 24 is then clipped to the loop 11 of the locking mechanism in the embodiment of FIG. 1, to the bumper in the embodiments of FIGS. 2 and 3 or to the edge of the wheel well in the embodiments of FIGS. 4 and 5. Of course, the S-hook 24 may be secured before the flat hook 25. It is also understood that the S-hook 24 may be attached to another portion of the vehicle body as well, such as to any fixture within the trunk or outside the trunk, in particular near a locking edge. The second end 22b of the second portion 22 of the strap 21, 22 is then pulled tightly away from the cam lock 27 in the direction of an arrow 23 to hold down the trunk lid, tail gate, door or doors shown in FIGS. 1-5. Alternatively, the handle 31 of the ratchet tightening mechanism 30 may be repeatedly rotated in the direction of an arrow 33 to hold down the trunk lid 5. As mentioned above, a spring cam buckle, O-ring, D-ring, side-release buckle, loop, cord lock, snap lock, center release buckle, tongue buckle or the like may be used as well.

It is important to note that the strap is tightened from the outside of and on top of the lid, tail gate, door or doors, where it is easily accessible without reaching into the trunk. The lid, tail gate, door or doors are thus held down without play when goods are placed in the trunk or cargo compartment, which do not allow the lid, tail gate, door or doors to be completely closed and locked with the locking mechanism.

1. A method for tying-down a cargo closure hinged to a body of a vehicle and having a hinged edge and a locking edge, the method comprising the following steps:
attaching a first portion of a strap to the vehicle body;
attaching a second portion of the strap to the hinged edge; and
tightening the strap to hold down the cargo closure.

2. The method according to claim 1, which further comprises carrying out the step of attaching the first portion of the strap to the vehicle body with a hook.

3. The method according to claim 1, which further comprises carrying out the step of attaching the second portion of the strap to the hinged edge of the cargo closure with a flat hook.

4. The method according to claim 2, which further comprises attaching the hook to a locking mechanism of the vehicle.

5. The method according to claim 2, which further comprises attaching the hook to a bumper of the vehicle.

6. The method according to claim 2, which further comprises attaching the hook to an edge of a wheel well of the vehicle.

7. The method according to claim 1, which further comprises carrying out the tightening step with a cam lock on the strap.

8. The method according to claim 1, which further comprises carrying out the tightening step with a ratchet tightening mechanism on the strap.

9. The method according to claim 1, which further comprises carrying out the tightening step from outside of a cargo area of the vehicle.

10. The method according to claim 1, which further comprises carrying out the tightening step from outside of the cargo closure.

11. In combination with a vehicle having a cargo closure being hinged to a body of the vehicle and having a hinge edge and a locking edge, a cargo closure tie-down comprising:
a strap having a first portion to be attached to the vehicle body and a second portion to be attached to the hinged edge of the cargo closure; and
a device for tightening the strap to hold down the cargo closure.

12. The cargo closure tie-down according to claim 11, which further comprises a hook for attaching said first portion of said strap to the vehicle body.

13. The cargo closure tie-down according to claim 11, which further comprises a flat hook for attaching said second portion of said strap to the hinged edge of the cargo closure.

14. The cargo closure tie-down according to claim 11, wherein said hook is configured to be attached to a locking mechanism of the vehicle.

15. The cargo closure tie-down according to claim 11, wherein said hook is configured to be attached to a bumper of the vehicle.

16. The cargo closure tie-down according to claim 11, wherein said hook is configured to be attached to an edge of a wheel well of the vehicle.

17. The cargo closure tie-down according to claim 11, wherein said tightening device is a cam lock disposed on said strap.

18. The cargo closure tie-down according to claim 11, wherein said tightening device is a ratchet tightening mechanism disposed on said strap.

19. The cargo closure tie-down according to claim 11, wherein said tightening device is operable from outside a cargo area of the vehicle.

20. The cargo closure tie-down according to claim 11, wherein said tightening device is operable from outside the cargo closure.
